(19) United States
(12) Patent Application Publication
(10) Pub. No.: US 2026/0036554 A1
(43) Pub. Date: Feb. 5, 2026

(54) Spectral Enhanced Surface Acoustic Wave Sensing Using Phononic And Photonic Interference

(71) Applicant: Board of Trustees of Michigan State University, East Lansing, MI (US)

(72) Inventors: Johannes POLLANEN, Lansing, MI (US); Pranaya Kishore RATH, East Lansing, MI (US)

(21) Appl. No.: 19/281,893

(22) Filed: Jul. 28, 2025

Related U.S. Application Data
(60) Provisional application No. 63/678,577, filed on Aug. 2, 2024.

(51) Int. Cl. G01N 29/24; G01N 29/04

(52) U.S. Cl. CPC G01N 29/2462; G01N 29/041; G01N 29/2437; G01N 2291/023; G01N 2291/0289; G01N 2291/101

(57) ABSTRACT

A SAW sensor includes a substrate comprising a first side and a second side and a ground plane disposed on the first side. The ground plane has a first portion separated from a second portion by a gap. An interdigitated transducer is disposed on the first side within the gap. A reflective acoustic such as a Bragg mirror is disposed adjacent to the interdigitated transducer within the gap to produce phononic Fano interference. A transmission line is disposed within the gap. The interdigitated transducer is coupled to the transmission line and to the first portion of the ground plane to produce photonic Fano interference.

### CROSS-REFERENCE TO RELATED APPLICATION

This application claims the benefit of U.S. Provisional Application No. 63/678,577, filed on Aug. 2, 2024. The entire disclosure of the above application is incorporated herein by reference.

### FIELD

The present disclosure relates to acoustic sensing using surface wave, bulk wave, or high-overtone bulk acoustic resonator (HBAR) sensing and, more specifically, to a spectrally enhanced acoustic wave sensors using phononic and photonic interference.

### BACKGROUND

This section provides background information related to the present disclosure which is not necessarily prior art.

Piezoelectric surface acoustic wave (“SAW”) devices, in general, are known. A SAW resonator is discussed in Kitzman, J., et al., “Quantum Acoustic Fano Interference of Surface Phonons,” Physical Review A 108, L010601 (2023), and Rieger, D., “Fano Interference in Microwave Resonator Measurements,” Physical Review Applied 20, 014059 (2023). Both of these publications are incorporated by reference herein.

Piezoelectric surface acoustic wave devices have many applications in various fields. Providing a design that provides adaptability into various configurations is desirable.

Bulk acoustic wave (BAW) and high-overtone bulk acoustic wave resonator (HBAR) sensors are known. These devices operate by confining an acoustic wave in the bulk of a substrate.

### SUMMARY

This section provides a general summary of the disclosure, and is not a comprehensive disclosure of its full scope or all of its features.

In accordance with the present invention, a sensor includes a surface acoustic wave resonator and an electromagnetic source, though the surface acoustic wave resonator could be replaced by a bulk acoustic wave resonator or HBAR sensor. Another aspect of the present sensor and a method of using the sensor include shaping a spectral response of a surface acoustic wave by combining interference of electromagnetic and piezo-mechanical signals. In yet another aspect, the present sensor and method include using Fano interference to enhance sensitivity of surface acoustic wave-based devices and sensors. A further aspect includes an interdigitated transducer (“IDT”) structure sandwiched between reflective surfaces, such as Bragg mirrors or alternately etched trench wall or upstanding wall boundary formations. In particular, the phononic interference can be controlled by increasing or decreasing the number of metallic fingers that define either the IDT structure or the Bragg mirrors, or both. In the case of bulk acoustic wave or HBAR devices the interference could be created by shaping the reflecting backside of the substrate containing the bulk acoustic waves or, as is the case with the SAW devices, engineering the electrical impedance of the microwave transmission line to which the acoustic sensors are connected.

The present sensor apparatus and method are advantageous over traditional devices. For example, the present sensor and method beneficially allow for more precise and pronounced frequency detection due to the suddenly changing slopes and sharp peaks of the spectrum of the amplitude as a function of frequencies, at a confined SAW resonant mode versus continuous background SAW modes. Similar spectral enhancements could be produced in bulk acoustic wave devices. This provides greater sensitivity of different resonator-based sensors.

Moreover, the present sensor apparatus and method advantageously create spectral shaping and sensing in a wide temperature range, such as from 10 mK to room temperature. This temperature range is ideally suited for sensing single elastic wave propagation in a quantum computer and for quantum acoustic sensing, industrial sensing (e.g., fluid flow measuring, microfluidic actuation, and the like) and/or communications (e.g., television and radio SAW resonators and filters).

More specifically, one aspect of the disclosure is a sensor that includes a substrate comprising a first side and a second side and a ground plane disposed on the first side. The ground plane has a first portion separated from a second portion by a gap. An interdigitated transducer is disposed on the first side within the gap. A reflective acoustic such as a Bragg mirror is disposed adjacent to the interdigitated transducer within the gap to produce phononic Fano interference. A transmission line is disposed within the gap. The interdigitated transducer is coupled to the transmission line and to the first portion of the ground plane to produce photonic Fano interference.

Another aspect of the disclosure includes, a sensor including a planar piezoelectric substrate comprising a first side and a second side. A ground plane is disposed on the first side. The ground plane has a first portion separated from a second portion by a gap. An interdigitated transducer is disposed on the first side within the gap. The interdigitated transducer has a first set of fingers interdigitated with a second set of fingers. A first set of Bragg mirrors and a second set of Bragg mirrors are disposed on opposite sides of the interdigitated transducer within the gap. A transmission line is disposed within the gap. The interdigitated transducer is coupled to the transmission line and to the first portion of the ground plane. The interdigitated transducer comprises two sets of interdigitated fingers a number of which is selected with a number of mirrors Bragg mirrors in the first set and second set to control the phononic interference.

In another aspect of the disclosure, a method includes communicating a surface or bulk acoustic wave having a signal frequency to a sensor comprising a transducer disposed on a substrate and a reflecting structure disposed adjacent to the transducer within a gap between two ground planes on the substrate. The sensor having a resonant mode. When the signal frequency corresponds to a resonant mode changing an output signal based on the resonant mode, generating an output signal based on the resonant mode and controlling a controlled device based on the output signal.

Further areas of applicability will become apparent from the description provided herein. The description and specific examples related to surface acoustic wave devices in this summary are intended for purposes of illustration only and are not intended to limit the scope of the present disclosure, which include bulk acoustic wave devices and HBAR devices.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a high level block diagrammatic view of a SAW sensor in a control system.

FIG. 2A is a high level view of the sensor 12.

FIG. 2B is an enlarged view of the SAW device.

FIG. 2C is an exaggerated representation of the SAW device of FIGS. 2A and 2B.

FIG. 2D is a detailed view of the SAW device according to the present disclosure.

FIG. 3 is a plot of transmission versus frequency of a transmission spectra.

FIG. 4 is a metallic microwave enclose for the sensor.

FIG. 5A is a plot of various signals showing a temperature change in Fano spectral line shape.

FIG. 5B shows a plot of transmission versus temperature in which a fitted Fano perimeter as a function of temperature is illustrated.

Corresponding reference numerals indicate corresponding parts throughout the several views of the drawings.

### DETAILED DESCRIPTION

Example embodiments will now be described more fully with reference to the accompanying drawings.

This sensor apparatus and method of using same employs an architecture and method involving the interference of trapped surface phonon modes of a surface acoustic wave device leading to Fano interference spectral structures, which are present over a wide range of temperatures from room temperatures to cryogenic temperatures. The highly sensitive nature of the Fano spectrum enhances the spectral response of the SAW resonator devices, making them a highly effective piezoelectric sensor suitable to be used both at classical and quantum regime. In particular, the phononic interference can be controlled by increasing or decreasing the number of metallic fingers that define either the IDT structure or the Bragg mirrors. Additionally, the existence of Fano spectral response at very low temperature makes the device suitable for quantum sensing.

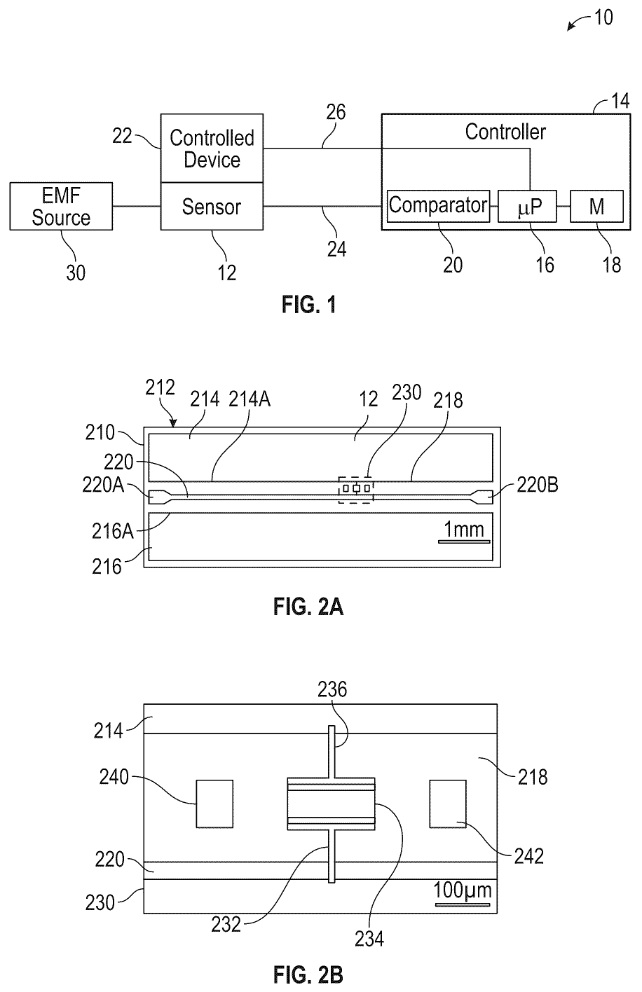

Referring now to FIG. 1, a control system 10 having a surface acoustic wave (SAW) sensor 12 is shown coupled to a controller 14. The controller 14 may include a microprocessor or processor 16 coupled to a memory 18. Although one processor 238 is illustrated several may be used in the system 10. The memory 18 may be a non-transitory computer-readable medium that includes instruction that are executable by the processor. The instructions may include instructions for controlling a controller device 22 based on an output signal 24 of the sensor 12.

A comparator 20 may also be disposed within the controller 14. The sensor 12 may be used to sense various conditions at or near the control device 22 or in a certain environment in which the control device 22 may be controlled based upon the output of the sensor 12. The output signal 24 of the sensor 12 may correspond to various conditions such as mass loading, temperature, pressure or strain change in the environment or on the controlled device 22. The controller 14 generates a control signal 26 used to control the control device 22.

The comparator 20 compares the output signals to, for example, a threshold that may be stored within the memory 18. Depending on the system, the control device 22 may be controlled based upon the output of the comparator 20. For example, if the mass loading, temperature, pressure or strain change is too great or too little, the control device 22 may be controlled by the controller 14 to act in a different way.

An RF or EMF source 30 may be coupled to the sensor 12 and the transmission line described below. The EMF source 30 may be a microwave source.

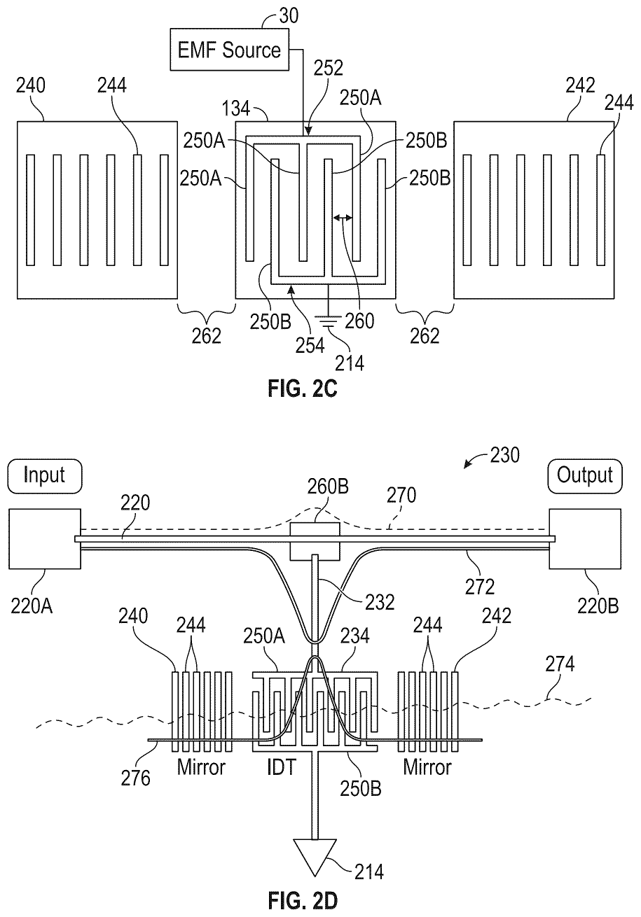

Referring now to FIG. 2A, a high level view of the sensor 12 is illustrated. The sensor 12 is formed on a substrate 210 formed of piezoelectric material. The substrate 210, in this example is a YZ axis cut lithium niobate substrate. Alternately, the substrate may be other materials such as quartz, zinc oxide, aluminum nitride, barium titanate, barium strontium titanate, and as thin films or bulk crystals. The substrate 210 has a ground plane 212 associated therewith. The ground plane 212 has a first portion 214 and a second portion 216. In the present example, the first portion 214 has a first edge 214A. The second portion 216 has a second edge 216A. The edges 214A, 216A and therefore the first portion 214 and second portion 216 have a gap 218 therebetween. In the present example, the gap 218 is formed by the parallel edges 214A and 216A.

A transmission line 220 is used to read out the spectral response of the device. In the present example, the transmission line 220 is parallel to the edges 214A and 216A. The transmission line 220 has pads 220A and 220B that used to connect to various equipment to perform the readout of the spectral response that is provided to the controller 14. One of the pads 220A or 220B may be coupled to the EMF source 30 illustrated in FIG. 1. The other pad 220A, 220B may be coupled to the controller 14 so that the spectral response may be obtained. The pad 220A may be referred to as an input pad and pad 220B an output pad. The sensor 12 includes a SAW sensor.

Referring now also to FIG. 2B, details of the SAW device 230 are set forth. In the present example, the SAW device is disposed between the transmission line 220 and one of the ground planes for which ground plane 214 is used by way of example. A conductor 232 couples an interdigitated transducer structure 234 to the transmission line 220. A conductor 236 couples the interdigitated transducer structure 234 to the ground plane 214. The interdigitated structure 234 is sandwiched between a first reflective mirror structure 240 and a second reflective mirror structure 242. In this example, a Bragg mirror structure is used as the reflective mirror structures 240, 242.

Referring now also to FIGS. 20, the mirror structures 240 and 242 are composed of two sets having a plurality of mirrors 244 that are shown in an exaggerated form. The actual configuration has more mirrors and more fingers. The mirrors 244 are reflective walls which are generally parallel to each other, with a spacing of 0-100 mm, and more preferably 0-10 mm from the IDT and from each other. There are approximately 10-10,000 Bragg mirrors on each side of the IDT, and more preferably 50-100 on each side. The interdigitated transducer structure 234 has a first plurality of fingers 250A and a second plurality of fingers 250B. The fingers 250A, 250B are disposed in a first set 252 and a second set 254. The fingers 250A, 250B are interdigitated because the gaps 252A are smaller than the size of the finger 250 in a set 254. The gaps 254A correspond to the width of the fingers 250 in the top set 252. Changing the number of fingers 250A, 250B can change the phononics.

The IDT finger spacing 260 is approximately 10 nm-10 μm from the center of one finger to the center of the adjacent finger, to set the desired frequency of the acoustic wave. The number of fingers may also be varied to set the desired frequency of the acoustic wave.

The spacing distance 262 from the IDT 234 and the reflective mirrors 240, 242 assists in setting the free propagation distance for the interference. The desired interference is created by a combination of the surface acoustic resonator (e.g., IDT and Bragg mirror configuration) plus the microwave EMF signals as provided by the radio frequency (“RF”) or EMF source 30. The EMF signal is preferably 100 MHZ-10 GHZ, and more preferably 1-5 GHz.

The transmission line 220 with the outer ground plane 212 with portion 214, 216 is designed in such a way that the effective impedance of the line is 50 ohms, matching with the external measurement devices. The sensor 12 may be coupled to transmission lines with different electrical impedance as well.

All the structures, i.e. the IDT 234, mirrors 240, 242, the transmission line 220 and the outer ground plane 214, in this example, are fabricated by depositing metallic layers using thermal or electron beam deposition. Based on the device design, the resonance frequency of the sensor 12 can be varied as to match the particular sensing requirement, over a wide range. At the same time, careful manipulation of the design parameters leads to a weakly trapped continuum phononic background along with the resonant acoustic modes. The SAW sensor 12 has the IDT 234 galvanically connected to the transmission line fabricated on a lithium niobate substrate.

Referring now to FIG. 2D, details of the SAW device 230 are illustrated relative to the various components above. A conductive junctive junction 268 electrically couples the transmission line 220 to the conductor 232. The complete measurement system is schematically illustrated in FIG. 2D with the absence of a measurement device connected to the output 220B, providing a conceptual framework for the integrated Fano interference mechanisms that give rise to asymmetric spectral line shapes in spectral response of the device. The resonant electromagnetic signal 272 introduced through the transmission line, gets transduced into SAW signals of both resonant modes 276 and a continuum background 274, giving rise to phononic Fano interference. The interfered acoustic signal is then transduced back into an electromagnetic signal, which subsequently interferes with the background electromagnetic leakage signal 270, constituting the photonic component of the Fano effect before being measured. Hence, the SAW device 230 produces asymmetric line shapes due to strong Fano interference of with both phononic and photonic contribution.

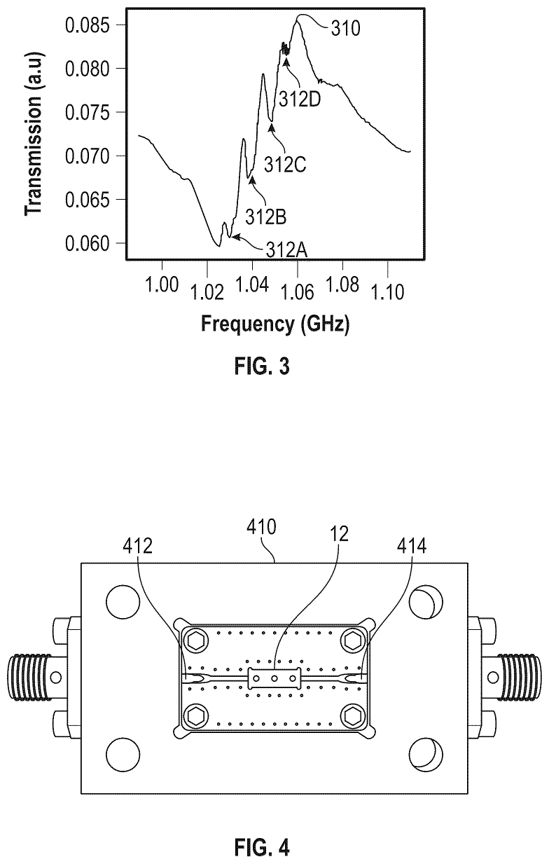

As best illustrated in FIG. 3, the considered device here is a multimode device with central resonant frequency 310 of 1.050 GHz over a continuum background, which is confirmed both experimentally from the spectral response of the device and theoretically by using SAW coupling of mode simulation analysis, but future sensing devices could operate over a much wider range of frequency, from 100 MHz to 10 GHz. Transmission spectra of the device showing the resonant modes 312A-312D (dips) along with a characteristic Fano line shape is set forth.

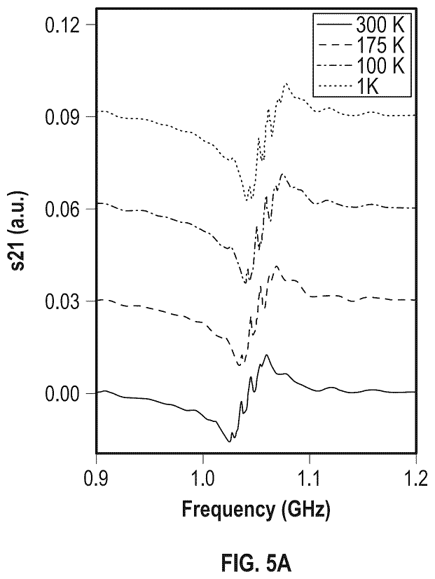

Referring now also to FIG. 4, to perform the spectral analysis of the sensor 12, the whole device is housed inside a metallic microwave enclosure 410 with an input pin 412 and an output pin 414 connected galvanically to the two ends of the transmission line 220. Housing the device inside a metallic cavity of the enclosure 410 prevents the device from interacting with external unwanted signals. A sinusoidal microwave signal with a frequency scan is applied to the transmission line and the transmission spectra of the system is recorded. In other realizations, pulsed microwave signals could be used to excite the device and the response would be recorded in the time-domain and Fourier transformed to obtain the frequency spectrum.

When the applied signal frequency is resonant with the SAW resonant modes, the signal gets absorbed by the SAW and resonantly excites the surface phonon modes, which can be observed as characteristic dips 312A-312D in the transmission spectra of FIG. 3. In addition to the expected dips in transmission, a Fano interference structure is also observed in the transmission spectra, due to the interaction of the surface resonant modes with the continuum weak background modes. As the Fano spectral structure results from the interaction of phononic modes, it is highly sensitive to the variation of velocity of sound on the surface of the substrate due to various parameters like mass loading, temperature or strain change in the system etc. Furthermore, the photonic interference of the microwave signal also contributes to the Fano lineshape and this can be modified by modifying the electrical impedance of the transmission line to which the acoustic resonator is attached.

The sensitivity of the Fano spectrum is quantified by the Fano parameter of the transmission spectra, which can be determined by fitting the spectrum with the following equation.

$$f ( ω ) = a ( \frac{{( q Γ / 2 + ω - {ω}_{0} )}^{2}}{{( Γ / 2 )}^{2} + {( ω - {ω}_{0} )}^{2}} )$$

Here, q is the Fano parameter, Γ is the linewidth of the spectrum, ω is the applied frequency, ω₀ is the resonance frequency of the Fano function, a is the scaling factor, whereas m and c parameterize the background slope and offset of the spectrum.

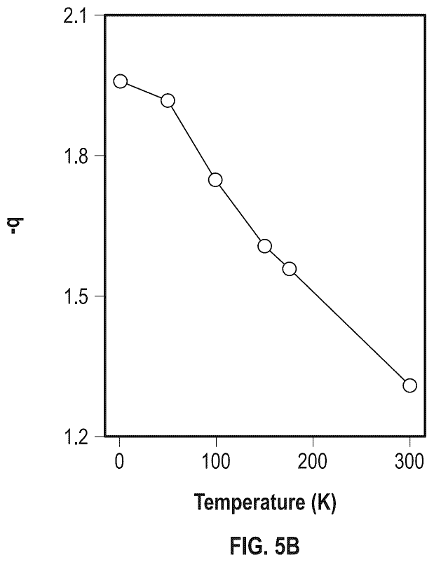

Referring now to FIGS. 5A and 5B, the effect of a temperature change on the device produces a prominent change in the Fano spectral line shape which makes the system a potential temperature sensor device. (FIG. 5A). Similar sensitivity is expected for mass-loading, pressure, and strain. Variation of transmission spectra of the device for various temperatures, where the curves have been shifted along Y-axis for clarity. The excitation of the Fano response in the device persists to very low temperature, suggesting a strong interaction between the resonant and continuum background (FIG. 5B) in which variation of the fitted Fano parameter as a function of temperature is illustrated.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java@, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python.

What is claimed is:

1. A sensor comprising:
a substrate comprising a first side and a second side;
a ground plane disposed on the first side, said ground plane comprising a first portion separated from a second portion by a gap;
an interdigitated transducer disposed on the first side within the gap;
a reflective mirror structure disposed adjacent to the interdigitated transducer within the gap to produce phononic Fano interference;
a transmission line disposed within the gap; and
said interdigitated transducer is coupled to the transmission line and to the first portion of the ground plane to generate photonic Fano interference.

2. The sensor of claim 1 wherein the substrate is composed of a piezoelectric material.

3. The sensor of claim 1 wherein the substrate is composed of YZ axes cut lithium niobate.

4. The sensor of claim 1 wherein the substrate is composed of quartz, zinc oxide, aluminum nitride, barium titanate, barium strontium titanate, and as thin films or bulk crystals.

5. The sensor of claim 1 wherein the first portion comprises a first edge and the second portion comprising a second edge, said first edge and said second edge defining the gap, said first edge and said second edge parallel to the transmission line.

6. The sensor of claim 1 wherein the structure to produce Fano interference comprises a first mirror structure disposed in the gap and a second mirror structure disposed in the gap, said interdigitated transducer disposed between the first mirror structure and the second mirror structure.

7. The sensor of claim 6 wherein the first mirror structure, and the second mirror structure comprise Bragg mirror structures.

8. The sensor of claim 6 wherein the first mirror structure comprises a first plurality of mirrors and the second mirror structure comprises a second plurality of mirrors.

9. The sensor of claim 8 wherein the first plurality of mirrors and the second plurality of mirrors are parallel to each other and perpendicular to the transmission line.

10. The sensor of claim 8 wherein a number of the first plurality of mirrors and the second plurality of mirrors are selected to control phononic interference.

11. The sensor of claim 1 wherein an impedance between the ground plane and transmission line is about 50 ohms.

12. The sensor of claim 1 wherein the interdigitated transducer and the reflective structure to produce Fano interference comprises a resonant frequency above 1.050 GHz.

13. The sensor of claim 1 wherein the interdigitated transducer comprises two sets of interdigitated fingers a number of which is selected to control phononic interference.

14. A sensor comprising:
a planar piezoelectric substrate comprising a first side and a second side;
a ground plane disposed on the first side, said ground plane comprising a first portion separated from a second portion by a gap;
an interdigitated transducer disposed on the first side within the gap, said interdigitated transducer comprises a first set of fingers interdigitated with a second set of fingers;
a first set of Bragg mirrors and a second set of Bragg mirrors disposed on opposite sides of the interdigitated transducer within the gap;
a transmission line disposed within the gap;
said interdigitated transducer coupled to the transmission line and to the first portion of the ground plane to generate photonic interference; and
the interdigitated transducer comprises two sets of interdigitated fingers a number of which is selected with a number of mirrors Bragg mirrors in the first set and second set to control the phononic interference.

15. A control system comprising:
the sensor of claim 1 generating an output signal; and
a controller controlling a controlled device based on the output signal.

16. The control system of claim 15 wherein the output signal corresponds to mass loading, temperature, pressure or strain change.

17. The control system of claim 15 wherein the substrate comprises a superconducting quantum processor substrate, the sensor comprises a quantum sensor and the output signal corresponds to sensing defect structures of the quantum processor substrate.

18. A method comprising:
generating surface acoustic wave signals at a surface acoustic wave sensor from an electromagnetic communicated though a transmission line to produce phononic Fano interference at the surface acoustic wave sensor, said surface acoustic wave sensor comprising an interdigitated transducer disposed on a substrate and a reflective structure disposed adjacent to the interdigitated transducer within a gap between two ground planes on the substrate, said sensor having a resonant mode;
based on generating and the resonant mode, generating an acoustic signal;
transducing the acoustic signal to form a second electromagnetic signal to generate a photonic Fano effect on an output signal of the transmission line based on the second electromagnetic signal interfering with a background electromagnetic leakage signal;
generating the output signal based on the photonic Fano interference and the phononic Fano interference; and
controlling a controlled device based on the output signal.

19. The method of claim 18 wherein generating surface acoustic wave signals comprises generating surface acoustic wave signals at the sensor in the resonant mode and continuum background.

20. The method of claim 18 further comprising controlling phononic interference by a number of mirrors to produce the Fano spectral structure and controlling a number of fingers.
